(19) United States
(12) Patent Application Publication
(10) Pub. No.: US 2009/0164404 A1
(43) Pub. Date: Jun. 25, 2009

(54) METHOD FOR EVALUATING PATENTS

(75) Inventors: Srinivasamurthy Sampath, Bangalore (IN); Angshuman Saha, Bangalore (IN); Raghunadh Vajjula, Bangalore (IN); Rohit Sharda, Noida (IN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/120,295

(22) Filed: May 14, 2008

(30) Foreign Application Priority Data
Dec. 24, 2007 (IN) 3087/CHE/2007

(51) Int. Cl. G06N 5/02

(52) U.S. Cl. 706/46

(57) ABSTRACT

A method includes extracting a plurality of patent parameters from each patent asset of a first data set comprising a first set of patent assets. The plurality of patent parameters of each patent asset of the first data set is fed to a decision tree tool. A decision tree involving interaction between the plurality of patent parameters is generated using a classification based methodology via the decision tree tool. Each patent asset of a second data set including a second set of patent assets is rated based on the generated decision tree. Each patent asset is provided a relative rating, an absolute rating, or a combination thereof.

### CROSS-REFERENCE TO RELATED APPLICATION

This application claims the benefit of a priority under 35 USC 119 to Indian Patent Application No. 3087/CIIE/2007, filed Dec. 24, 2007, entitled “METHOD FOR EVALUATING PATENTS”, the entire contents of which is hereby incorporated by reference.

### BACKGROUND

The invention relates generally to evaluation of patents, and more specifically, to a method for evaluating patents based on a classification methodology for effective intellectual property management.

Patents play an important role in industrial progress, providing information about innovations to the society and stimulating developments of further improvements. Increasing number of patent applications are being filed in Patent Offices around the world each year. New areas for patenting innovations become available, including software inventions, business methods related inventions and certain types of life forms. Triggered by enormous growth of the patent system, the exploitation of patents and other activities involving patents are also growing tremendously. Each year larger numbers of patents are being licensed and cross-licensed, involved in infringement and/or validity studies, used in advanced research and development programs, and are taken into account in mergers, acquisitions and venture capital financing. In all of the above-mentioned activities, there is an urgent need for accurate and consistent evaluation of the patents involved.

Usually, patent evaluations are based solely on opinions of experts in certain technology areas, being sometimes enhanced by second opinions provided by lawyers, accountants or other professionals. The evaluation of the same patent may vary significantly depending on qualifications of the experts and their own evaluation criteria. In addition, experts' opinions may be biased, and since different experts may have different levels of bias, the consistency of patent evaluation may suffer to the point of rendering the evaluation project nearly useless. Clearly, such an approach is not practical for evaluating patent documents, especially when large quantities of patents are involved.

All of the above mentioned patent evaluation approaches are based on the idea of collecting suitable information about a patent under evaluation and transforming it into a monetary value of the patent. One of the problems is that the amount of information that can be collected about an average patent is large. It is not immediately clear how many parameters are required to properly characterize a patent, and what are those parameters. However, the choice of parameters has a profound effect on the validity and quality of the patent evaluation. The improper choice of patent parameters may render the method of evaluation useless at best and disastrous at worst, especially if a substantial amount of money is involved.

Unfortunately, most of the proposed methods of patent evaluation fail at the very beginning of the evaluation process when deciding on a set of parameters to characterize a patent. A shortcoming in the area of patent evaluation is a lack of automated and consistent analysis and interpretation of the evaluation results. Normally, the evaluation of a patent document and interpretation of the evaluation results is carried out by experts. However, it has at least four serious deficiencies that make the practical value of such interpretation questionable: the interpretation is often subjective, heavily based on expert's knowledge and experience which may differ from patent to patent and from expert to expert; it defeats the goals of keeping the level of consistency in the patent evaluation process as high as possible; it slows down the evaluation process; and it makes the evaluation process more expensive.

There is a need for a more consistent and effective technique for evaluating patents

### BRIEF DESCRIPTION

In accordance with one exemplary embodiment of the present technique, a computer-implemented method for evaluating a patent asset is disclosed. The method includes extracting a plurality of patent parameters from each patent asset of a first data set comprising a first set of patent assets, each patent asset having a predetermined rating. The plurality of patent parameters of each patent asset of the first data set is fed to a decision tree tool. A decision tree involving interaction between the plurality of patent parameters is generated using a classification based methodology via the decision tree tool. Each patent asset of a second data set having a second set of patent assets is rated based on the generated decision tree. Each patent asset is provided a relative rating, an absolute rating, or a combination thereof.

In accordance with another exemplary embodiment of the present invention, a method of operating a computer system for evaluating a patent asset is disclosed. The method includes creating a data set including a plurality of patent assets and feeding the data set to a patent database. The patent database is used to extract a plurality of patent parameters from each patent asset of a data set. Rating for each patent asset of the data set is obtained by using a decision tree tool for deriving decisions related to intellectual property management.

### DRAWINGS

These and other features, aspects, and advantages of the present invention will become better understood when the following detailed description is read with reference to the accompanying drawings in which like characters represent like parts throughout the drawings, wherein:

FIG. 1 is a flow chart illustrating exemplary steps involved in method of evaluating one or more patent assets of a data set in accordance with an exemplary embodiment of the present technique disclosed herein;

FIG. 2 is a diagrammatical representation of a computer system configured to implement an exemplary embodiment of the present technique disclosed herein;

FIG. 3 is a flow chart illustrating exemplary steps involved in generating a decision tree for evaluating one or more patent assets of a data set in accordance with an exemplary embodiment of the present technique disclosed herein;

FIG. 4 is a diagrammatical representation of a data sheet used for creating data set including a plurality of patent assets in accordance with an exemplary embodiment of the present technique disclosed herein; and

FIG. 5 is a diagrammatical representation of a decision tree generated using a decision tree tool in accordance with an exemplary embodiment of the present technique disclosed herein.

### DETAILED DESCRIPTION

As discussed in detail below, embodiments of the present technique provide a computer-implemented method for evaluating one or more patent assets in a data set including one or more patent assets. The method includes extracting a plurality of patent parameters from each patent asset of a first data set including a first set of patent assets. The first data set may also be referred to as “training data set”. Each patent asset of the first data set has a predetermined rating. The patent parameters of each patent asset of the first data set are then fed to a decision tree tool. A decision tree involving interaction between the patent parameters is generated using a classification based methodology via the decision tree tool. In one embodiment, the classification based methodology is a statistical methodology. The statistical methodology is explained in greater detail below. The decision tree is used to rate each patent asset of a second data set including a second set of patent assets. Each patent asset is provided a relative rating, an absolute rating, or a combination thereof. In one embodiment, obtained rating of each patent asset of the second data set is validated with a corresponding predetermined rating of the respective patent asset of the second data set. The decision tree may be finalized based on the validation result. In another exemplary embodiment, a method for operating a computer system for evaluating a patent asset is disclosed. In accordance with the embodiments of the present technique, correlation between a set of patent parameters (bibliographic data) is used to rate or evaluate a patent asset. By using easily extractable bibliographic data and by employing a classification based methodology, the rating of each patent asset is ascertained. Human judgment is avoided for evaluation and consistency is enhanced.

It is a fundamental observation that not all intellectual property assets are created equal. In the case of patent assets, for example, two patents even in the same industry and relating to the same subject matter can command drastically different royalty rates in a free market, depending upon a variety of factors. These factors may include, for example, the premium or incremental cost consumers are willing to pay for products or services embodying the patented technology; the economic life of the patented technology and/or products; the cost and availability of competing substitute technology and/or products; and the quality of the underlying patent asset.

The quality of a patent in terms of the breadth or scope of rights secured, its defensibility against validity challenges and its commercial relevance may have particularly dramatic impact on its value. Obviously, a patent that has a very narrow scope of protection or that is indefensible against a validity challenge may have much less value than a patent that has a broad scope of protection and strong defensibility. A skilled patent lawyer can examine the claims and specification of a patent, its prosecution history and cited prior art and, based on a detailed legal analysis, render a subjective opinion as to the likely scope and defensibility of the patent. However, such legal work is time-intensive and expensive. Thus, it may not be economically feasible to consult a patent lawyer in every situation where such information may be desired.

In one embodiment, the exemplary technique provides an objective, statistical-based classification method for substantially independently assessing rating of individual patent assets. The exemplary technique may be applicable for a training data set including a plurality of training patent assets, and also for new patent assets not included in the training data set. Thus, the exemplary technique can provide new and valuable information that can be used by patent valuation experts, investment advisors, economists and others to help guide future portfolio management, patent investment decisions, licensing programs, patent appraisals, tax valuations, transfer pricing, economic forecasting and planning, maintenance fee payments, due diligence for mergers and acquisitions, and even mediation and/or settlement of patent litigation lawsuits. Such information may include, for example and without limitation ratings or rankings of individual patents or patent portfolios; ratings or rankings of patent portfolios held by public corporations; ratings or rankings of patent portfolios held by pre-IPO companies; ratings or rankings of individual named inventors; and ratings or rankings of professional service firms, law firms and the like who prepare, prosecute and enforce patents assets.

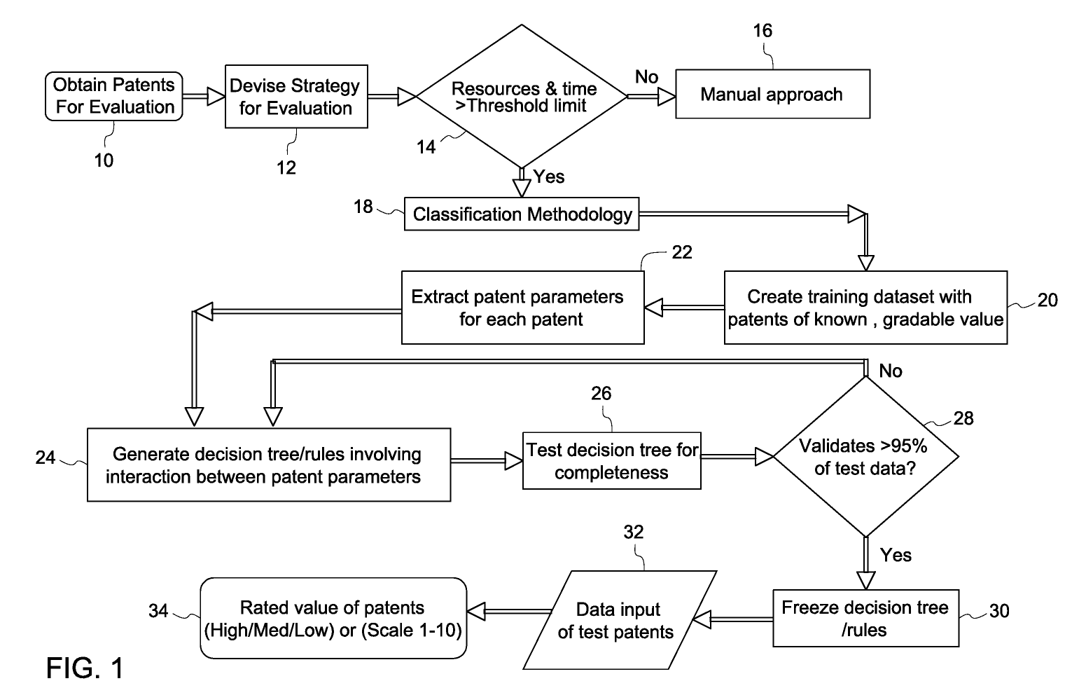

Referring to FIG. 1, a flow chart for evaluating one or more patent assets in a data set in accordance with an exemplary embodiment of the present technique is illustrated. The technique includes obtaining a training data set (first data set) including a plurality of patent assets for evaluation as represented by the step 10. A strategy is devised for evaluation of the patent assets as represented by the step 12. The available resources and time availability for evaluation is compared with a threshold limit as represented by the step 14. If the resources and time availability is less than a threshold limit then a manual approach is adopted for evaluation as represented by the step 16. If the resources and time availability is greater than a threshold limit, then a classification based methodology is adopted as represented by the step 18. In the illustrated embodiment, the classification based methodology is a statistical based classification methodology.

The patent assets in the training data set are categorized based on known gradable value as represented by the step 20. In one embodiment, the patent assets may be classified into one set of patents with higher quality rating, another set of patents with medium quality rating, and yet another set of patents with lower quality rating. A plurality of patent parameters are extracted from each patent asset as represented by the step 22. This may involve feeding the training data set to a commercially or a freely available patent database and then extracting the patent parameters from the database. Such patent parameters may include any number of quantifiable parameters that directly or indirectly measure or report a quality or characteristic of a patent. Direct patent metrics measure or report those characteristics of a patent that are revealed by the patent itself, including its basic disclosure, drawings and claims, as well as the patent office record or file history relating to the patent. Specific patent metrics may include, for example and without limitation, the number of claims, number of words per claim, number of different words per claim, word density (e.g., different-words/total-words), length of patent specification, number of drawings or figures, number of cited prior art references, number of collaborations, age of cited prior art references, number of subsequent citations received, subject matter classification and sub-classification, origin of the patent (foreign vs. domestic), payment of maintenance fees, prosecuting attorney or firm, patent examiner, examination art group, length of pendency in the PTO, claim type, life remaining on the patent, family members (i.e. method, apparatus, system), etc. In one embodiment, the patent parameters may include but not limited to forward citations, backward citations, number of claims, family size, prosecution time, number of inventors, remaining life term, number of international patent classification codes, geographical coverage, or combinations thereof of each patent asset.

In one example with reference to a patent “X”, forward citations may be referred to patents that give citations/references to the patent X and Backward citation may be referred to as searching for the patents that the patent X cites/references. Family size may be computed as number of countries in which patents were granted for the same invention. Prosecution may be referred to as the interaction between an applicant, or their representative, and a patent office with regard to a patent, or an application for a patent. Life term of a patent may be referred to as time period for which a patent protection is valid. International patent classification code system may be referred to as a hierarchical system in which the whole area of a technology is divided into a range of sections, classes, subclasses and groups. Geographical coverage may be referred to as geographic area in which patent is filed and over which patent coverage is required.

Indirect patent metrics measure or report a quality or characteristic of a patent that, while perhaps not directly revealed by the patent itself or the patent office records relating to the patent, can be determined or derived from such information (and/or other information sources). Examples of indirect patent metrics include reported patent litigation results, published case opinions, patent licenses, marking of patented products, and the like. Indirect patent metrics may also include derived measures or measurement components such as frequency or infrequency of certain word usage relative to the general patent population or relative to a defined sub-population of patents in the same general field.

The technique includes feeding the extracted patent parameters of the patent assets to a decision tree tool. A decision tree/rules involving interaction between the plurality of patent parameters is generated as represented by the step 24. The generation of a decision tree involves starting from a root node and splitting the root node into children nodes. Each child node may be further split into subsequent child nodes. Splitting of a particular node is done out based on logical criteria on patent parameters. In one example, such criteria are based on whether a particular parameter exceeds a threshold value or below a threshold value. Each node is representative of a particular subset of the set of patent assets. The further splitting of a node is controlled based on one or more node criteria including node size, node depth, and node purity. Node size, node depth, and node purity are defined below with reference to subsequent figures. The decision tree is checked for completeness as represented by the step 26. For any patent parameter, if the values associated with the particular patent parameter in a particular node are identical for all the patent assets in the data set, then the particular patent parameter is not used to split the node further. The step is repeated for all the extracted patent parameters to determine whether the particular node is to be split further. The decision tree is also subjected to pruning to enhance capacity to generalize rating on patent assets, which are not part of the training data set. Pruning is referred to as removing subsequent children nodes from a particular parent node. The pruning is continued until there is a statistically significant increase in the misclassification rate using the tree. To compute the increase in misclassification rate, a test data set (second data set) is used to evaluate any increase in misclassification in rating of patent assets due to pruning. A set of patent assets for such evaluation may be randomly selected or based on specific characteristics. The generated decision tree may be further converted to a set of decision rules. The decision rules are dependent on the confidence level/support of the test data set. For validation purpose, the confidence level/support of a particular rule for the test data set is compared to threshold limit as represented by the step 28. In one embodiment, a particular rule is not generated if the confidence level is less than 95 percent of the test data set. If the confidence level is greater than the threshold limit, then the decision tree is finalized as represented by the step 30. The generation of decision tree is explained in greater detail with reference to subsequent figures below. The decision tree is finalized as represented by the step 30. The generation of decision tree is explained in greater detail with reference to subsequent figures below. It should be noted herein that the purpose of the finalized decision tree is to provide rating for new patent assets (i.e. patent assets not listed in the training data set) having unknown rating as represented by the step 32. The rating may include a relative rating, absolute rating, or combination thereof as represented by the step 34. Relative rating may include a high, medium, or low rating of the patent asset. Absolute rating may include a suitable value range/scale, e.g. value in the range of 1 to 10.

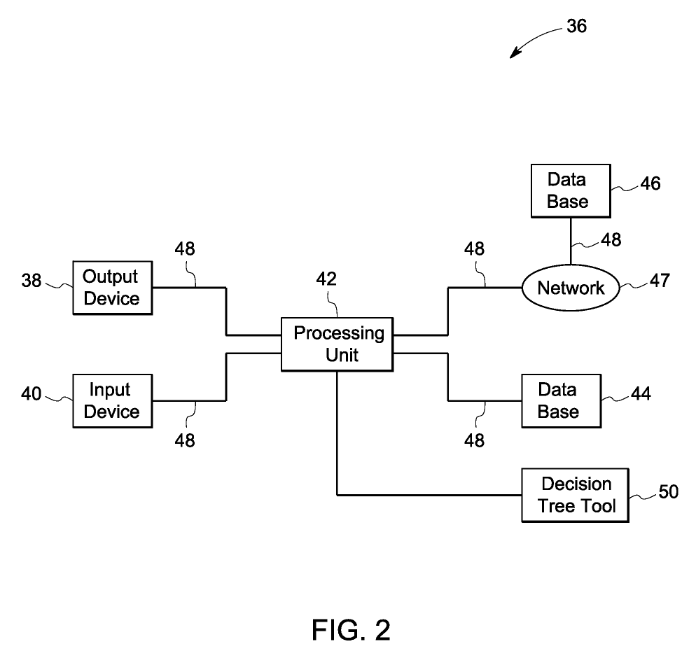

Referring to FIG. 2, a computer system 36 configured to implement an exemplary embodiment of the present technique disclosed herein is illustrated. The computer system 36 may be a personal computer, a workstation or a system including more than one single computer unit, which are linked together, e.g. a client-server-system with a plurality of users. Thus the computer system 36 may be designed as a one computer system or as a distributed system, e.g. a client-server-system. Furthermore the computer system 36 includes an input device 38 and an output device 40 coupled to a processing unit 42. The input device 38 may include a keyboard and a mouse and the output device 40 may include monitor, printer, or the like. The input device 38 and/or the output device 40 are used to create a data set including plurality of patent assets. The processing unit also includes a memory (not shown) including a random access memory (RAM), read only memory (ROM) and/or other components. The computer system 36 operates under control of an operating system stored in the memory to present data including patent numbers and respective ratings to an operator via the display screen of the monitor and to accept and process commands from the operator via the input device 40. A computer-readable medium, e.g., one or more removable data storage devices or a fixed data storage device store the operating system, software applications, and other code configured to carry out the embodiments discussed herein. The storage devices may include removable media drives and/or removable storage media, such as floppy discs, compact discs, digital video discs, flash memory, USB pen drives, and so forth. The storage devices also may include hard disk drives.

Furthermore the processing unit 42 has access to one or more internal data bases 44 and external data bases 46. The access to external data bases 46 may be accomplished e.g. via an external network 47, for example the internet or an intranet. The components of the computer system 36 are connected via wired or non-wired interfaces 48. The external databases 46 may include any free or commercially available databases known to those skilled in the art. The connection to the data bases 44, 46 may be offline or online, depending e.g. on the frequency of the need of evaluating patents. The created data set is fed to the internal and external databases 44, 46. In one exemplary embodiment, the external database 46 is used to extract the plurality of patent parameters of each patent asset in the data set.

In the illustrated embodiment, the processing unit 42 has access to a decision tree tool 50 configured to generate a decision tree involving interaction between the plurality of extracted patent parameters using a classification based methodology such as a statistical based classification methodology. The extracted patent parameters of the patent assets is fed to a decision tree tool either automatically or manually. As discussed previously, the splitting of nodes while generating a decision tree is controlled based on one or more node criteriors including node size, node depth, and node purity. In certain embodiments, the user may have the option of selecting threshold limits for the node criteriors. Similarly, in certain embodiments, the user may have the option of deciding whether the decision tree should be subjected to pruning. An exemplary embodiment of the formation of the decision tree is explained in greater detail below.

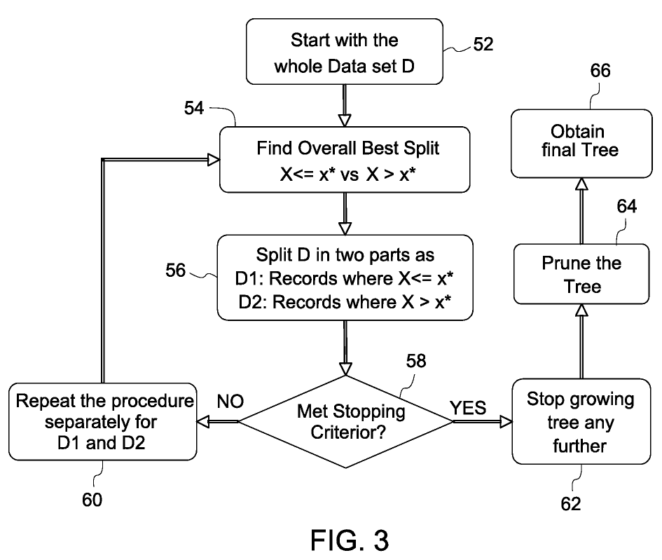

Referring to FIG. 3, a flow chart illustrating exemplary steps involved in generating a decision tree for evaluating one or more patent assets of a data set in accordance with an exemplary embodiment of the present technique disclosed herein is illustrated. A plurality of patent parameters (X1, X2 . . . Xn) of each patent asset of a training data set “D” are extracted and fed to a decision tree tool as represented by the step 52. The tool evaluates the data set to determine an overall “best split” for the extracted patent parameters as represented by the step 54. In the illustrated embodiment, determining the best split involves determining a cut-off value of each patent parameter for classifying each patent asset of the data set. In one example, cut-off-values (x1*, x2* . . . xn*) are determined respectively for the plurality of patent parameters (X1, X2 . . . Xn). For a particular patent parameter, iterative looping is done for all cut-off values. For example, for patent parameter (X1), the best cut-off value (x1*) is determined by evaluating all cut-off values (C1, C2, . . . Cn). In other words, the best cut-off value is determined by evaluating the best split among all the cut-off values. For each cut-off value, the patent assets of the data set are classified into two categories as represented by the step 56. One category would include patent assets having the particular patent parameter value less than or equal to the respective cut-off value and the other category would include patent assets having the particular patent parameter value greater than the respective cut-off value. A “percentage of impurity” is computed for each of the category. “Percentage of impurity” is referred to as number of patent assets in the particular category expressed as a percentage. If the percentage of impurity in the one category is greater than the other category, the process is repeated for the next subsequent cut-off value. If the percentage of impurity in the one category is less than the other category, a cut-off value preceding the current cut-off value is selected as the best split. The process is continued until a best split for a cut-off value is identified. Determining the overall best split includes determining the best parameter among the all the extracted patent parameters and its associated best split for a cut-off value.

The generation of a decision tree involves starting from a root node and iteratively generating one or more parent nodes and splitting each node into one or more subsequent nodes in accordance with the steps described above. The method includes determining whether node splitting criteria are met as represented by the step 58. The splitting of nodes is controlled based on one or more node criteria including node size, node depth, and node purity. “Node size” of a particular node may be referred to as number of patent assets categorized in the particular node. “Node depth” of a particular node may be referred to as number of nodes starting from a first node to the particular node of a particular branch of the decision tree. In one embodiment, the splitting of a particular node is stopped if the node size of the particular node is less than a threshold node size limit. In another embodiment, the splitting of a particular node is stopped if the node purity of a particular node is greater than a threshold node purity limit. In yet another embodiment, the splitting of a particular node is stopped if the node depth of a particular node is greater than a threshold node depth limit. The threshold limit of the node size, node purity, and node depth may be varied depending upon the application.

For any patent parameter, if the values associated with the particular patent parameter in a particular node are identical for all the patent assets in the data set, then the particular patent parameter is not used to split the node further. If the above described criteriors are not met, the process of determining the overall best split is repeated as represented by the step 60. The step is repeated for all the extracted patent parameters to determine whether the particular node is to be split further. If the above-described criteria are met, the growth of decision tree is stopped as represented by the step 62. Then the decision tree is also subjected to pruning as represented by the step 64. A test data set is used to evaluate any increase in misclassification in rating of patent assets due to pruning. A set of patent assets for such evaluation may be randomly selected or based on specific characteristics. Pruning is done so as to generalize the decision tree for evaluating patent assets, which are not part of the data set used for generating the decision tree. The decision tree is finalized after pruning as represented by the step 66.

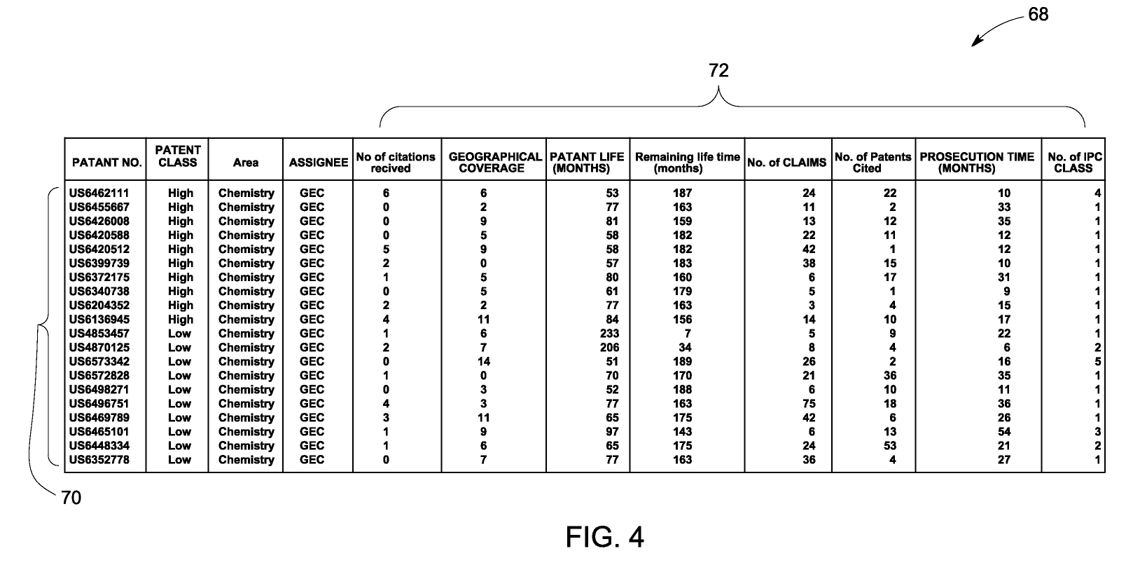

Referring to FIG. 4, a diagrammatical representation of a data sheet 68 used for creating a data set including a plurality of patent assets 70 in accordance with an exemplary embodiment of the present technique disclosed herein is illustrated. The patent assets in the training data set are categorized based on known gradable value as represented by the step 20. In illustrated embodiment, the patent assets may be classified into one set of patents with higher quality rating, and another set of patents with lower quality rating. A parameter set 72 including plurality of patent parameters are extracted from each patent asset. This involves feeding the data set to a commercially or a freely available patent database and then extracting the patent parameters from the database. Such patent parameters may include any number of quantifiable parameters that directly or indirectly measure or report a quality or characteristic of a patent. In the illustrated embodiment, the patent parameters include forward citations, geographical coverage, patent life term, remaining life term, number of claims, backward citations, prosecution time, number of IPC classes, number of collaborators, number of inventors, and non-patent literature citations. The extracted parameters are fed to the decision tree tool configured to generate a decision tree used for evaluation of patent assets.

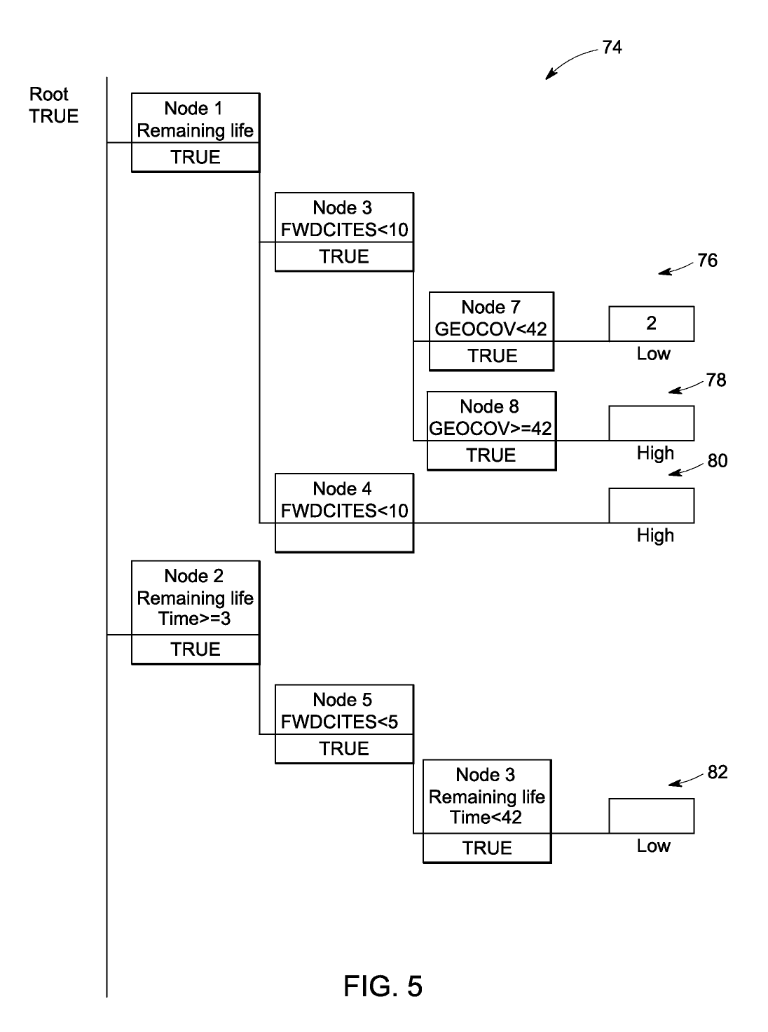

Referring to FIG. 5, a diagrammatical representation of a decision tree 74 generated using a decision tree tool in accordance with an exemplary technique disclosed herein is illustrated. The generation of a decision tree involves starting from a root node and iteratively generating one or more nodes and splitting each node into one or more subsequent nodes in accordance with the steps described above.

In the illustrated embodiment, the decision tree 74 includes 4 branches 76, 78, 80, and 82. The first branch 76 includes 3 nodes: node 1, node 3, and node 7. Node 1 is representative of remaining lifetime less than 3, node 3 representative of forward citation less than 10, and node 7 representative of geographical coverage less than 42. If all three conditions of the branch 1 are met, then a patent asset may be provided a lower rating. The second branch 78 includes 3 nodes: node 1, node 3, and node 8. Node 8 is representative of geographical coverage greater than or equal to 42. If all three conditions of the second branch 78 are met, then a patent asset may be provided a higher rating. The third branch 80 includes 2 nodes: node 1 and node 4. Node 4 is representative of forward citation greater than or equal to 18. If the two conditions of the third branch 80 are met, then a patent asset may be provided a higher rating. The fourth branch 82 includes 3 nodes: node 2, node 5, and node 9. Node 2 is representative of remaining life greater than or equal to 3, node 5 representative of forward citation less than 5, and node 9 representative of remaining lifetime less than 42. If all three conditions of the fourth branch 82 are met, a patent asset may be provided a lower rating. It should be noted herein that the illustrated decision tree is an exemplary embodiment and its associated values should not be construed as limiting. The number of branches, nodes and associated parameter values may vary depending on the application.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A computer-implemented method for evaluating a patent asset; comprising:
extracting a plurality of patent parameters from each patent asset of a first data set comprising a first set of patent assets; wherein each patent asset of the first data set has a predetermined rating;
feeding the plurality of patent parameters of each patent asset of the first data set to a decision tree tool;
generating a decision tree involving interaction between the plurality of patent parameters using a classification based methodology via the decision tree tool; and
rating each patent asset of a second data set comprising a second set of patent assets, based on the generated decision tree; wherein each patent asset of the second data set is provided a relative rating, an absolute rating, or a combination thereof.

2. The method of claim 1, comprising extracting a plurality of patent parameters comprising forward citations, backward citations, number of claims, family size, prosecution time, number of inventors, remaining life term, number of international patent classification codes, number of collaborations, geographical coverage, or combinations thereof.

3. The method of claim 1, wherein generating a decision tree involving interaction between the plurality of patent parameters comprises splitting a root node into children nodes.

4. The method of claim 3, further comprising controlling splitting of each node based on a plurality of parameters related to the respective node.

5. The method of claim 5, comprising controlling splitting of each node when a node size of the respective node is less than a threshold node size limit.

6. The method of claim 4, comprising controlling splitting of each node when a purity of the respective node is greater than a threshold node purity limit.

7. The method of claim 4, comprising controlling splitting of each node when a depth of the respective node is greater than a threshold node depth limit.

8. The method of claim 3, further comprising pruning the leaf nodes.

9. The method of claim 1, wherein the relative rating comprises a high, medium, and low rating.

10. A computer-implemented method for evaluating a patent asset; comprising:
extracting a plurality of patent parameters from each patent asset of a first data set comprising a first set of patent assets;
feeding the plurality of patent parameters of each patent asset of the first data set to a decision tree tool;
generating a decision tree involving interaction between the plurality of patent parameters using a classification based methodology via the decision tree tool; and
rating each patent asset of a second data set comprising a second set of patent assets based on the generated decision tree; wherein each patent asset is provided a relative rating, an absolute rating, or a combination thereof; and
validating the obtained rating of each patent asset of the second data set with a corresponding predetermined rating of the respective patent asset of the second data set.

11. The method of claim 10, comprising extracting a plurality of patent parameters comprising forward citations, backward citations, number of claims, family size, prosecution time, number of inventors, remaining life term, number of international patent classification codes, number of collaborations, geographical coverage, or combinations thereof.

12. The method of claim 10, wherein generating a decision tree involving interaction between the plurality of patent parameters comprises splitting a root node into children nodes.

13. A computer-implemented method for evaluating a patent asset; comprising:
extracting a plurality of patent parameters from each patent asset of a first data set comprising a first set of patent assets;
feeding the plurality of patent parameters of each patent asset of the first data set to a decision tree tool;
generating a decision tree involving interaction between the plurality of patent parameters using a classification based methodology via the decision tree tool; and
rating each patent asset of a second data set comprising a second set of patent assets based on the generated decision tree; wherein each patent asset is provided a relative rating, an absolute rating, or a combination thereof; and
validating obtained rating of each patent asset of the second data set with a corresponding predetermined rating of the respective patent asset of the second data set;
finalizing the generated decision tree based on validation of obtained rating of each patent asset of the second data set with the corresponding rating of the respective patent asset of the second data set.

14. The method of claim 13, wherein generating a decision tree involving interaction between the plurality of patent parameters comprises splitting a root node into children nodes.

15. A method of operating a computer system for evaluating a patent asset, comprising:
creating a data set comprising a plurality of patent assets;
feeding the data set to a patent database;
using the patent database to extract a plurality of patent parameters from each patent asset of a data set comprising a plurality of patent assets;
obtaining rating for each patent asset of the data set by using a decision tree tool for deriving decisions related to intellectual property management.

16. The method of claim 14, wherein intellectual property management comprises portfolio management, licensing, maintenance fee payments, due diligence for mergers and acquisitions, or combinations thereof.

17. The method of claim 15, wherein the plurality of patent parameters comprises forward citations, backward citations, number of claims, family size, prosecution time, number of inventors, remaining life term, number of international patent classification codes, number of collaborations, geographical coverage, or combinations thereof.

18. The method of claim 15, further comprising using a decision tree tool to generate a decision tree involving interaction between the plurality of patent parameters using a classification based methodology.

19. The method of claim 18, comprising using the decision tree tool to split a root node into children nodes.

20. The method of claim 19, further comprising using one or more node parameters for controlling splitting of the respective node.

21. The method of claim 20, comprising using a node size for controlling splitting of the respective node.

22. The method of claim 20, comprising using a node purity for controlling splitting of the respective node.

23. The method of claim 20, comprising using a node depth for controlling splitting of the respective node.

24. The method of claim 15, further comprising selecting a relative rating, an absolute rating, or combinations thereof for displaying rating of each patent asset of the data set.

25. A computer program for evaluating a patent asset, the computer program comprising:
programming instructions stored in a tangible medium that enable extraction of a plurality of patent parameters from each patent asset of a first data set comprising a first set of patent assets; wherein each patent asset of the first data set has a predetermined rating;
programming instructions stored in a tangible medium that enable feeding of the plurality of patent parameters of each patent asset of the first data set to a decision tree tool;
programming instructions stored in a tangible medium that enable generating a decision tree involving interaction between the plurality of patent parameters using a classification based methodology via the decision tree tool; and
programming instructions stored in a tangible medium that enable rating each patent asset of a second data set comprising a second set of patent assets, based on the generated decision tree; wherein each patent asset of the second data set is provided a relative rating, an absolute rating, or a combination thereof.
